(19) United States
(12) Patent Application Publication
(10) Pub. No.: US 2007/0065020 A1
(43) Pub. Date: Mar. 22, 2007

(54) Image procession method and device

(75) Inventor: Ching-Yu Ko, Tai Chung City (TW)

Correspondence Address: BIRCH STEWART KOLASCH & BIRCH, PO BOX 747, FALLS CHURCH, VA, 22040-0747, US

(73) Assignee: Alpha Imaging Technology Corp.

(21) Appl. No.: 11/476,672

(22) Filed: Jun. 29, 2006

(30) Foreign Application Priority Data
Jul. 25, 2005 (TW) 094125048

(51) Int. Cl. G06K 9/36

(52) U.S. Cl. 382/232

(57) ABSTRACT

An image compression/decompression method is provided for compressing/decompressing image data. First, each pixel of the raw image data is received. Then, each pixel of the raw image data is compared with a default transparent code to recognize whether the pixel in the raw image data is a transparent code pixel. Finally, a single transparent code pixel or one transparent code pixel of a sequence of transparent code pixels is stored, and a total length information of the single transparent code pixel or the sequence of the transparent code pixels is acquired.

### BACKGROUND OF THE INVENTION

(a) Field of the Invention

The invention relates to an image procession method and device, and particularly to an image compression/decompression method and device.

(b) Description of the Related Art

A conventional image display system, such as a digital capture system or a capture with sticker system, usually overlaps several images before displaying them, and the overlapped images may be compressed as JPEG (Joint Photographic Experts Group) format files. FIG. 1 shows images A, B, and C are overlapped and merged into an image D.

The conventional image display system adopts a transparent decoding mechanism, in which certain feature such as a kind of color is defined as a transparent code. Namely, pixels with identical transparent codes are treated as transparent code pixels. Next, the image display system reads images of each frame from a memory unit and recognizes whether the pixels of the images are transparent code pixels. The transparent code pixels are not displayed, and their original display areas are replenished by pixels of other frames likewise placed in the same areas. For example, referring to FIG. 2, when an image display system reads all the pixels P1-Pn and T1-Tn of an image, the transparent code pixels T1-Tn are not displayed, and the original display areas of the transparent code pixels T1-Tn are replenished by pixels of other frames likewise placed in the same areas.

Referring to FIG. 1, it is seen the resolution of the image A is 160×160 and that of the images B and C are both 160×120. Assume the image format is RGB656 and each pixel size occupies 2 bytes, the total memory space required for reading the image D equals 128 K bytes(=160×160×2 (A)+160×120×2 (B)+160×120×2 (C)), where the memory space required for the transparent code pixels equals 58 K bytes(=160×120×2 (transparent code region of A)+160×120×2×0.5 (transparent code region of C; assuming one half full-size is enclosed). Therefore, the transparent code pixels of the images A, B, and C may occupy one half of the sum of their total memory space when the image D is read out.

However, since the improvement of frame-rate in data reading often restricted by the size of a memory unit, a real-time image display system, such as a viewfinder system, a capture with sticker system or a digital camera capture system, fails to simultaneously process and display the overlapped image D that carries considerable data amount. Also, the huge data amount of the overlapped image D may result in a reduced number of images that can be stored in the memory unit.

### BRIEF SUMMARY OF THE INVENTION

Hence, an object of the invention is to provide an image compression/decompression method to reduce occupied memory space of an image and the number of access times during image display.

The subject invention provides an image compression method for compressing raw image data. First, each pixel of the raw image data is received. Then, each pixel of the raw image data is compared with a default transparent code to recognize whether the pixel in the raw image data is a transparent code pixel. Finally, a single transparent code pixel or one transparent code pixel of a sequence of transparent code pixels is stored, and total length information of the single transparent code pixel or the series of the sequential transparent code pixels is acquired.

Further, the subject invention also provides an image decompression method for decompressing compressed image data, wherein the compressed image data include multiple pixels, at least one transparent code pixel and at least one total length information for recording the length of transparent code pixels. First, the compressed image data are received. Then, each pixel of the compressed image data is compared with a default transparent code to judge whether the received compressed image data are a transparent code pixel. Finally, a specific number determined according to the total length information of the transparent code pixels is outputted.

Through the design of the invention, a plenty of transparent code pixels in the overlapped images are replaced by at least one transparent code pixel together with its appended total length information, so that the occupied memory space of the overlapped images are reduced. Thus, the frame-rate in data reading of a real-time image display system can be improved.

### BRIEF DESCRIPTION OF THE DRAWINGS

FIG. 1 shows a schematic diagram illustrating images A, B, and C that are overlapped and merged into an image D.

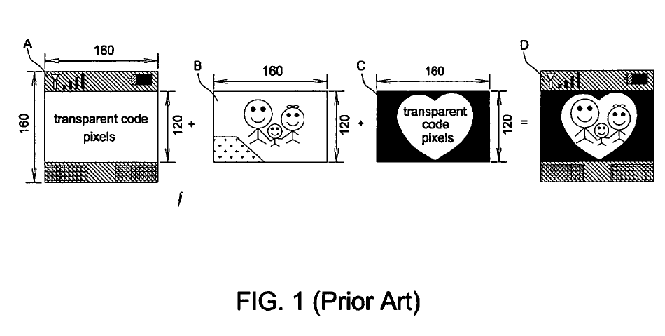

FIG. 2 shows a schematic diagram illustrating an image reading operation for reading pixels of image A.

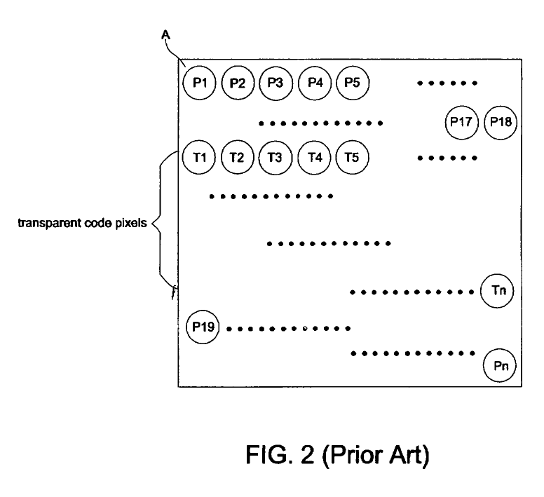

FIG. 3A shows a schematic diagram of raw image data E.

FIG. 3B shows a schematic diagram of compressed image data E′.

FIG. 4 shows a flowchart illustrating an image compression method of the invention.

FIG. 5 shows a flowchart illustrating an image decompression method of the invention.

FIG. 6 shows a schematic diagram illustrating an image compression device of the invention.

FIG. 7 shows a schematic diagram illustrating an image decompression device of the invention.

### DETAILED DESCRIPTION OF THE INVENTION

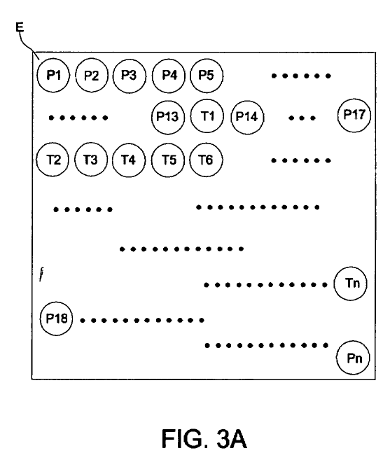

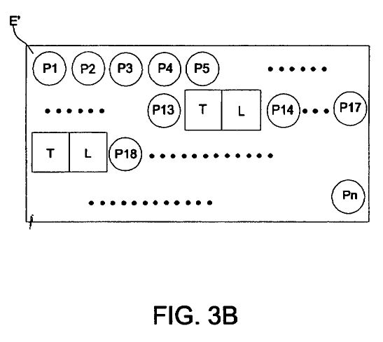

FIG. 3A shows an image E, and FIG. 3B shows its compressed image E′ created by the image compression method of the invention. Referring to FIG. 3A, the pixels of the image E are first divided into two groups, i.e. transparent code pixels T1-Tn and ordinary pixels P1-Pn. Referring to both FIG. 3A and FIG. 3B, the ordinary pixels P1-Pn are directly stored in a memory unit, while the transparent code pixels T1-Tn are compressed in advance. As shown in FIG. 3A, when a single transparent code pixel T1 sandwiched between P13 and P14 is encoded, it is stored into the memory unit as a transparent code field T, and meanwhile the length information m regarding one pixel is acquired by means of a calculator and stored into the memory unit as a length field L. On the other hand, when other transparent code pixels T2-Tn are decoded, any one of them (such as a transparent code pixel T2) is stored into the memory unit as transparent code field T, and meanwhile the total length information m regarding pixels T2-Tn is calculated out by a calculator and stored into the memory unit as a length field L. The transparent code field T or the length field L occupies a memory space of only two bytes. Certainly, the occupied memory space can be arbitrarily adjusted to meet different display formats and display size.

Thereby, under the treatment of overlapping the images A, B, and C and compressing them into the image D, the occupied space of the image D equal to 70 k(=128 k−58 k) bytes is reduced to about half of its original occupied space (128 k bytes). Hence, through the design of the invention, the occupied memory space is considerably decreased and the access speed of the image display system is improved to easily achieve a real-time display.

Note that the representation of the total length information m includes, but is not limited to, the number, bytes, or occupied areas of pixels. Alternatively, it can be a user-defined parameter. Besides, the format of pixels is not limited and may be a RGB format, a YUV format, or a user-defined format.

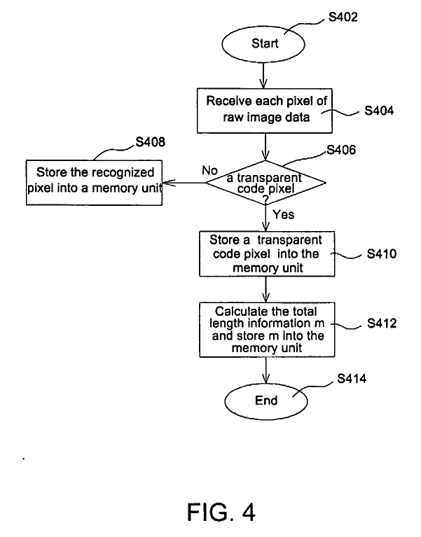

FIG. 4 shows a flow chart illustrating an image compression method of the invention used to compress raw image data. For instance, the raw image E shown in FIG. 3A is compressed and transformed into the target image E′ shown in FIG. 3B. The compression steps are described as follows:
Step S402: Start
Step S404: Receive each pixel of raw image data.
Step S406: Compare each pixel of the raw image data with the default transparent code to recognize whether the pixel in the raw image data is a transparent code pixel. If no, go to the step S408; if yes, go to step S410.
Step S408: Store the recognized pixel into a memory unit.
Step S410: Store a single transparent code pixel or one transparent code pixel of a sequence of transparent code pixels into the memory unit, where each transparent code pixel is stored into the memory unit as a transparent code field T.
Step S412: Acquire the total length information m of the single transparent code pixel or the sequence of the transparent code pixels by means of a calculator or a counter/adder. The total length information m is appended to the transparent code pixel, and they are together stored into the memory unit, where the total length information m is stored into the memory unit as a length field L.
Step S414: End.

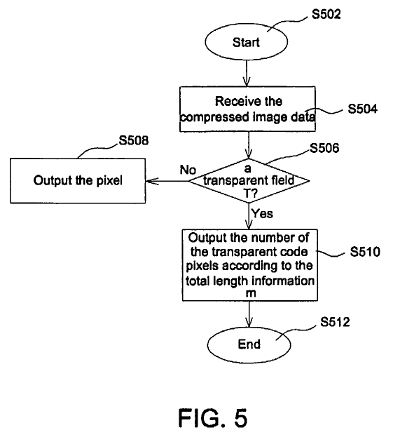

FIG. 5 shows a flow chart illustrating an image decompression method of the invention used to decompress compressed image data. For instance, the compressed image E′ shown in FIG. 3B is decompressed and transformed into the raw image E shown in FIG. 3A. The compressed image data include multiple pixels, at least one transparent code field T (containing a transparent code pixel), and at least one length field L (containing total length information m) for recording the length of transparent code pixels. The length field L is appended to the transparent code field T. The decompression steps are described as follows:
Step S502: Start.
Step S504: Receive the compressed image data.
Step S506: Compare each pixel of the compressed image data with the default transparent code to judge whether the received image data are a transparent field T (transparent code pixel). If no, go to the step S508; if yes, go to step S510.
Step S508: Output the received pixel.
Step S510: Output the number of the transparent code pixels according to the total length information m of the length field L appended to the transparent code field T.
Step S512: End.

According to the decompression method of the invention, the transparent code pixel is read out from the memory unit through the indication of the transparent code field T, and the total length information m is read out from the memory unit through the indication of the length field L. For example, assume that a transparent code field T contains a transparent code pixel T50 and an appended length field L, the image display system outputs the transparent code pixel T50 according to the total length information m. Also, assume that another transparent code field T contains a transparent code pixel T100, and the appended total length information m of a length field L equals to 5 pixels. Then it indicates the original image data includes a sequence of 5 transparent code pixels in which the transparent code pixel T100 is also included. As a result, when the image data in a memory unit are read, only the ordinary pixels P1-Pn, the transparent code field T, and the length field L are required to be read out, but not all the transparent code pixels T1-Tn as described in the conventional method. Therefore, the occupied memory and the number of access times are all reduced to result in a fine real-time image display.

Hence, the image compression/decompression method according to the invention is suitable for a real-time display system such as a viewfinder system, capture with sticker system, digital camera capture system, digital video camera capture system etc. However, this is not limited and the image compression/decompression method also suitable for other image display or data storage systems. Further, since the occupied memory and the number of access times are all reduced through the invention, the power consumption, the memory access bandwidth, and the complexity in decompression circuit design are all decreased as a result.

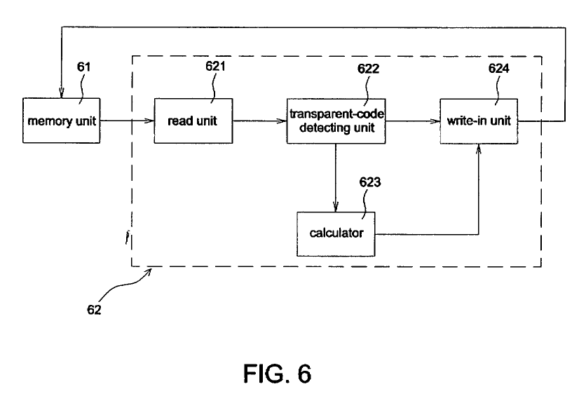

FIG. 6 shows a schematic diagram illustrating an image compression device according to the invention. The image compression device 62 is used to compress raw image data including multiple pixels and used to store the compressed image data into a memory unit 61. For instance, the original image E shown in FIG. 3A is compressed and transformed into the compressed image E′ shown in FIG. 3B. The image compression device 62 includes a read unit 621, a transparent-code detecting unit 622, a calculator 623, and a write-in unit 624.

The read unit 621 fetches the raw image data from the memory unit 61 or the real-time image capture system (not shown). The transparent-code detecting unit 622 receives the raw image data and compares each pixel with a default transparent code. If ordinary pixels are detected, the transparent code detecting unit 622 outputs these pixels to the write unit 624, and then they are stored into the memory unit 61. On the contrary, if a single transparent code pixel or a sequence of transparent code pixels are detected, the transparent-code detecting unit 622 also outputs them to the write unit 624. Next, the write-in unit 624 saves the single transparent code pixel into the memory unit 61 as a transparent code field T, or saves one of the sequence of the transparent code pixels into the memory unit 61 as another transparent code field T. Meanwhile, the calculator 623 computes the total length of the single pixel or the sequence of the transparent code pixels and outputs it to the write unit 624. Finally, the write unit 624 saves this total length information m into the memory unit 61 as a length field L.

Note that in this embodiment, the calculator 623 may be a counter, adder, or other devices capable of performing calculation and data recording. The total length information m is appended to the transparent code pixels and stored into the memory unit 61. Also, the representation of the total length information m includes, but is not limited to, the number, bytes or occupied areas of pixels. Alternatively, it can be a user-defined parameter. Besides, the format of pixels is not limited and may be a RGB format, a YUV format, or a user-defined format.

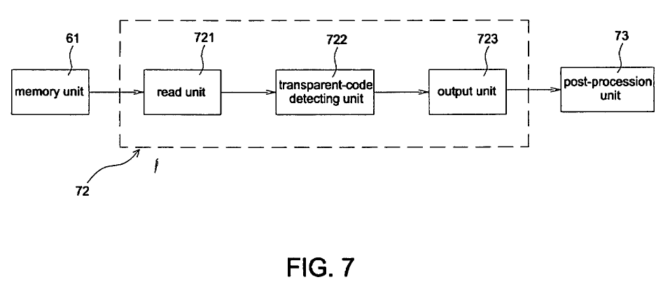

FIG. 7 shows the schematic diagram illustrating an image decompression device according to the invention. The image decompression device 72 is used to decompress a compressed image. For instance, the compressed image E′ shown in FIG. 3B is decompressed and transformed into the raw image E shown in FIG. 3A. The compressed image data include multiple pixels, at least one transparent field T (containing a transparent code pixel), and at least one length field L (containing total length information m) for recording the length of transparent code pixels. The length field L is appended to the transparent code field T, i.e. the total length information m is appended to the transparent code pixels contained in the transparent code field T. The image decompression device includes a read unit 721, a transparent-code detecting unit 722, and an output unit 723.

The read unit 721 fetches the compressed image data from the memory unit 61. The transparent-code detecting unit 722 receives the compressed image data and compares each pixel with a default transparent code. In that case, the transparent code field T, i.e. the transparent code pixel, is detected and delivered to the output unit 723. When the ordinary pixels are detected, the output unit 723 outputs these pixels to a post-procession unit 73 for subsequent image processing treatments. When the transparent code field T, i.e. the transparent code pixel, is detected, the output unit 723outputs the number of the transparent code pixels to the post-procession unit 73 for subsequent image processing treatments, where the number of the transparent code pixels is determined according to the total length information m of the length field L appended to the transparent code field L.

Note that the post-procession unit 73 may be an ordinary display unit, a compression unit, or another type of image procession unit.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art.

What is claimed is:

1. An image compression method for compressing raw image data, comprising the steps of:
receiving each pixel of the raw image data;
comparing each pixel of the raw image data with a default transparent code to recognize whether the pixel in the raw image data is a transparent code pixel; and
storing a single transparent code pixel or one transparent code pixel of a sequence of the transparent code pixels, and acquiring total length information of the single transparent code pixel or the sequence of the transparent code pixels.

2. The image compression method as claimed in claim 1, wherein the total length information is acquired by means of a calculator.

3. The image compression method as claimed in claim 1, wherein the calculator is a counter or an adder.

4. The image compression method as claimed in claim 1, wherein the transparent code pixel is stored into a memory unit as a transparent code field.

5. The image compression method as claimed in claim 1, wherein the total length information is stored into a memory unit as a length field, and the length field is appended to the transparent code pixel.

6. The image compression method as claimed in claim 1, wherein the total length information is represented as the number, bytes or occupied areas of pixels, or a user-defined parameter, and the format of the pixels is a RGB format, YUV format or a user-defined format.

7. An image decompression method for decompressing compressed image data, wherein the compressed image data include multiple pixels, at least one transparent code pixel, and at least one total length information, the image decompression method comprising the steps of:
receiving the compressed image data;
comparing each pixel of the compressed image data with a default transparent code to judge whether the received compressed image data are a transparent code pixel; and
outputting a specific number of transparent code pixels, wherein the specific number is determined according to the total length information.

8. The image decompression method as claimed in claim 7, wherein the transparent code pixel is read out from a memory unit through the indication of a transparent code field.

9. The image decompression method as claimed in claim 7, wherein the total length information is read out from a memory unit through the indication of a length field.

10. The image decompression method as claimed in claim 7, wherein the total length information is represented as the number, bytes or occupied areas of pixels, or a user-defined parameter, and the format of the pixels is a RGB format, YUV format or a user-defined format.

11. An image compression device, which is used to compress raw image data including multiple pixels, comprising:
a read unit for fetching the raw image data;
a transparent-code detecting unit for comparing each pixel with a default transparent code to recognize whether the pixel in the raw image data is a transparent code pixel; and
a write-in unit for storing a single transparent code pixel or one transparent code pixel of a sequence of transparent code pixels, and saving total length information of the single transparent code pixel or the sequence of transparent code pixels.

12. The image compression device as claimed in claim 11, wherein the total length information is acquired by means of a calculator.

13. The image compression method as claimed in claim 12, wherein the calculator is a counter or an adder.

14. The image compression device as claimed in claim 11, wherein the transparent code pixel is stored into a memory unit as a transparent code field.

15. The image compression device as claimed in claim 11, wherein the total length information is stored into a memory unit as a length field and the length field is appended to the transparent code pixel.

16. The image compression device as claimed in claim 11, wherein the total length information is represented as the number, bytes or occupied areas of pixels, or a user-defined parameter, and the format of the pixels is a RGB format, YUV format or a user-defined format.

17. An image decompression device, which is used to decompress a compressed image data including multiple pixels, at least a transparent code pixel, and at least one total length information, the image decompression device comprising:
a read unit for fetching the compressed image data;
a transparent-code detecting unit for comparing each pixel of the compressed image data with a default transparent code to judge whether the received compressed image data are a transparent code pixel; and
an output unit for outputting a specific number of transparent code pixels, wherein the specific number is determined according to the total length information.

18. The image decompression device as claimed in claim 17, wherein the transparent code pixel is read out from a memory unit through the indication of a transparent code field.

19. The image decompression device as claimed in claim 17, wherein the total length information is read out from a memory unit through the indication of a length field.

20. The image decompression device as claimed in claim 17, wherein the total length information is represented as the number, bytes or occupied areas of pixels, or a user-defined parameter, and the format of the pixels is a RGB format, YUV format or a user-defined format.
